(19) United States
(12) Patent Application Publication
(10) Pub. No.: US 2026/0309631 A1
(43) Pub. Date: Oct. 8, 2026

(54) MATERIAL TESTING SYSTEMS AND ASSOCIATED COMPONENTS AND METHODS

(71) Applicant: Battelle Energy Alliance, LLC, Idaho Falls, ID (US)

(72) Inventors: Zilong Hua, Ammon, ID (US); Jorgen F. Rufner, Idaho Falls, ID (US); David H. Hurley, Idaho Falls, ID (US); Robert S. Schley, Rigby, ID (US)

(21) Appl. No.: 19/475,716

(22) PCT Filed: Apr. 19, 2024
(86) PCT No.: PCT/US2024/025388

§ 371 Date: Oct. 15, 2025

Related U.S. Application Data
(60) Provisional application No. 63/497,522, filed on Apr. 21, 2023.

(51) Int. Cl. G01N 21/71

(52) U.S. Cl. CPC G01N 21/718; G01N 2201/06113; G01N 2201/088

(57) ABSTRACT

A non-destructive testing system includes a laser having an adjustable modulation frequency. The system further includes a first mirror configured to intercept and redirect thermal electromagnetic radiation released by a structure after the laser heats a surface of a material of the structure. The system also includes a second mirror configured to intercept, redirect, and concentrate the thermal electromagnetic radiation after the thermal electromagnetic radiation is intercepted and redirected by the first mirror. The system further includes a detector configured to receive and measure the thermal electromagnetic radiation after the thermal electromagnetic radiation is intercepted, redirected, and concentrated by the second mirror.

### CROSS-REFERENCE TO RELATED APPLICATIONS

This application is a national phase entry under 35 U.S.C. § 371 of International Patent Application PCT/US2024/025388, filed Apr. 19, 2024, designating the United States of America and published as International Patent Publication WO 2024/263242 A1 on Dec. 26, 2024, which claims the benefit under Article 8 of the Patent Cooperation Treaty of U.S. Patent Application Ser. No. 63/497,522, filed Apr. 21, 2023.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### TECHNICAL FIELD

Embodiments of the present disclosure generally relate to non-destructive testing systems and methods. In particular, embodiments of the disclosure relate to non-destructive testing systems and associated components and methods.

### BACKGROUND

Thermal transport is some materials, such as, advanced nuclear fuels may be tied to reactor efficiency and safety. Thermal transport may correlate to a microstructure of the associated material. Microstructure features, such as natural grain boundaries, irradiation induced damage, bonding interface, and larger-scale defect clusters and pores may influence thermal conductivity of the associated material.

### BRIEF SUMMARY

Embodiments of the disclosure include a non-destructive testing system. The system includes a laser having an adjustable modulation frequency. The system further includes a first mirror configured to intercept and redirect thermal electromagnetic radiation released by a structure after the laser heats a surface of a material of the structure. The system also includes a second mirror configured to intercept, redirect, and concentrate the thermal electromagnetic radiation after the thermal electromagnetic radiation is intercepted and redirected by the first mirror. The system further includes a detector configured to receive and measure the thermal electromagnetic radiation after the thermal electromagnetic radiation is intercepted, redirected, and concentrated by the second mirror.

Another embodiment of the disclosure includes a method of measuring a thermal diffusivity of a structure. The method includes heating a surface of a material of the structure with a laser having a first modulation frequency. The method further includes measuring a first value of thermal electromagnetic radiation released by the structure. The method also includes storing, in a memory device, the first value of the thermal electromagnetic radiation released by the structure. The method further includes changing a modulation frequency of the laser to a second modulation frequency different from the first modulation frequency. The method also includes heating the surface of the material of the structure with the laser having the second modulation frequency. The method further includes measuring a second value of the thermal electromagnetic radiation released by the structure at the second modulation frequency. The method also includes storing, in the memory device, the second value of the thermal electromagnetic radiation released by the structure. The method further includes changing the modulation frequency of the laser to a third modulation frequency different from the first modulation frequency and the second modulation frequency. The method also includes heating the surface of the material of the structure with the laser having the third modulation frequency. The method further includes measuring a third value of the thermal electromagnetic radiation released by the structure at the third modulation frequency. The method also includes storing, in the memory device, the third value of the thermal electromagnetic radiation released by the structure. The method further includes extrapolating a thermal diffusivity curve of the structure using the first value, the second value, and the third value. The method also includes identifying the thermal diffusivity of the structure as a value of the thermal diffusivity curve in a boundary region of the thermal diffusivity curve.

Other embodiments of the disclosure include a method of forming a structure. The method includes filling a mold with a material. The method further includes sintering the material in the mold while applying a current to the material. The method also includes measuring a thermal diffusivity of the material in the mold. The method further includes calculating a density of the material in the mold using the thermal diffusivity of the material.

### BRIEF DESCRIPTION OF THE DRAWINGS

While the disclosure concludes with claims particularly pointing out and distinctly claiming embodiments of the disclosure, the advantages of embodiments of the disclosure may be more readily ascertained from the following description of embodiments of the disclosure when read in conjunction with the accompanying drawings in which:

FIG. 1 illustrates a schematic view of a non-destructive testing system in accordance with embodiments of the disclosure;

FIG. 2 illustrates a flow chart representative of a method of measuring a thermal diffusivity of a structure in accordance with embodiments of the disclosure;

FIG. 3 illustrates a plot of thermal diffusivity and curve fit error over modulation frequencies in accordance with embodiments of the disclosure;

FIG. 4 illustrates a flow chart representative of a method of calculating a density of a material in accordance with embodiments of the disclosure;

FIG. 5 is a plot illustrating a relationship between porosity of a material and thermal conductivity of the material in accordance with embodiments of the disclosure; and

FIGS. 6A and 6B illustrate electron microscope images of different regions of a material in accordance with embodiments of the disclosure.

### DETAILED DESCRIPTION

The following description provides specific details, such as material compositions, shapes, and sizes, in order to provide a thorough description of embodiments of the disclosure. However, a person of ordinary skill in the art would understand that the embodiments of the disclosure may be practiced without employing these specific details. Indeed, the embodiments of the disclosure may be practiced in conjunction with conventional techniques employed in the industry.

Drawings presented herein are for illustrative purposes only, and are not meant to be actual views of any particular material, component, structure, device, or system. Variations from the shapes depicted in the drawings as a result, for example, of manufacturing techniques and/or tolerances, are to be expected. Thus, embodiments described herein are not to be construed as being limited to the particular shapes or regions as illustrated, but include deviations in shapes that result, for example, from manufacturing. For example, a region illustrated or described as box-shaped may have rough and/or nonlinear features, and a region illustrated or described as round may include some rough and/or linear features. Moreover, sharp angles that are illustrated may be rounded, and vice versa. Thus, the regions illustrated in the figures are schematic in nature, and their shapes are not intended to illustrate the precise shape of a region and do not limit the scope of the present claims. The drawings are not necessarily to scale. Additionally, elements common between figures may retain the same numerical designation.

As used herein, the terms “configured” and “configuration” refers to a size, a shape, a material composition, a material distribution, orientation, and arrangement of at least one feature (e.g., one or more of at least one structure, at least one material, at least one region, at least one device) facilitating use of the at least one feature in a pre-determined way.

As used herein, the term “substantially” in reference to a given parameter means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, “about” or “approximately” in reference to a numerical value for a particular parameter is inclusive of the numerical value and a degree of variance from the numerical value that one of ordinary skill in the art would understand is within acceptable tolerances for the particular parameter. For example, “about” or “approximately” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, relational terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the drawings. Unless otherwise specified, the spatially relative terms are intended to encompass different orientations of the materials in addition to the orientation depicted in the figures. For example, if materials in the figures are inverted, elements described as “below” or “beneath” or “under” or “on bottom of” other elements or features would then be oriented “above” or “on top of” the other elements or features. Thus, the term “below” can encompass both an orientation of above and below, depending on the context in which the term is used, which will be evident to one of ordinary skill in the art. The materials may be otherwise oriented (e.g., rotated 90 degrees, inverted, flipped) and the spatially relative descriptors used herein interpreted accordingly.

As used herein, the singular forms “a,” “an,” and “the” are intended to include the plural forms as well, unless the context clearly indicates otherwise.

As used herein, the term “and/or” means and includes any and all combinations of one or more of the associated listed items.

As used herein, the terms “vertical,” “longitudinal,” “horizontal,” and “lateral” are in reference to a major plane of a structure and are not necessarily defined by earth's gravitational field. A “horizontal” or “lateral” direction is a direction that is substantially parallel to the major plane of the structure, while a “vertical” or “longitudinal” direction is a direction that is substantially perpendicular to the major plane of the structure. The major plane of the structure is defined by a surface of the structure having a relatively large area compared to other surfaces of the structure.

Electric Field Assisted Sintering (EFAS), also commonly referred to as Spark Plasma Sintering (SPS), is an advanced manufacturing technique for the thermal processing of numerous material systems. Primarily, it is used with metal and ceramic powders for rapid and energy efficient consolidation into dense parts but can also be used to process bulk solid materials. During EFAS, a voltage bias is applied to a top and bottom ram between which the sample/tooling assembly is located. Uniaxial compression is also applied to the tooling. Electrical current flows through percolation pathways in the graphite tooling including the sample material if it is electrically conductive. This generates heat via internal resistive heating throughout the tooling/sample ensemble, which facilitates much more efficient heat transfer compared to similar technologies, i.e., hot pressing, hot isostatic pressing, or free sintering. This efficiency leads to reduced time needed at temperature, which translates to energy savings that can be as high as 80-90%. In EFAS systems, the single signal available to infer sample consolidation is movement of the rams as the powder compact densifies. Ram movement may be correlated to sample bulk density if it can be assumed that the sample is primarily shrinking in the direction of ram movement. No in situ experimental approach is conventionally used to monitor microstructural variations, such as percent porosity. Conventional experimentation to determine percent porosity includes time intensive, destructive analyses such as surface polishing and microscopy. Parts produced through EFAS may also include local microstructure variations. High heating rates of hundreds of degrees per minute in addition to extremely efficient heat transfer allows materials to quickly reach target temperatures. While adding to the efficiency of the EFAS systems, this high heating rate can lead to temperature gradients inside the part, generating unexpected microstructural heterogeneities such as the variation of porosity and grain size. An in situ instrument that can measure local density of parts may facilitate the detection of local porosity and density measurements in a non-destructive manner.

A similar process, known as Continuous Electric Field Assisted Sintering (CEFAS), utilizes rollers that are configured to effect a form factor change of a material passing through the system. The rollers are heated in a similar manner to the mold of an EFAS system, by passing a current through the rollers. In some embodiments, the current passes through each roller individually. In other embodiments, the current passes from one roller through the material being sintered to the other roller. The heat may be transferred to the material by the rollers or generated internally in the material by the current passing therethrough. Similar to EFAS systems, the high heating rates of hundreds of degrees per minute in addition to extremely efficient heat transfer allows materials to quickly reach target temperatures. This high heating rate can lead to temperature gradients inside the part, generating unexpected microstructural heterogeneities such as the variation of porosity and grain size. An in situ instrument that can measure local density of parts may facilitate the detection of local porosity and density measurements in a non-destructive manner as they pass through the CEFAS system or immediately after the parts leave the CEFAS system.

Thermal transport properties of a material may closely correlate to microstructure of the material. Local thermal diffusivity of materials may be measured using photothermal radiometry (PTR). The thermal diffusivity may then be correlated to a local density in a region of the material where the thermal diffusivity was measured through PTR. In PTR measurements, an intensity-modulated laser is used to locally heat a sample of the material and excite thermal waves, of which the propagation is probed by collecting blackbody radiation at different locations. The PTR signal amplitude increases with emissivity and thus the measurement can be conducted on industrial grade surfaces (e.g., surfaces that are not specially prepared) of the material. Blackbody radiation intensity and PTR signal levels increase with temperature, such that measurement accuracy improves in the high-temperature environments.

Thermal transport properties in nuclear fuels and materials contribute to the efficiency and safety of an associated nuclear reactor. Therefore, measuring thermal diffusivity of materials within a nuclear reactor or before the materials are used in a nuclear reactor may result in improved efficiency and safety of the associated nuclear reactor and improved monitoring of the nuclear fuels during operation of the reactor.

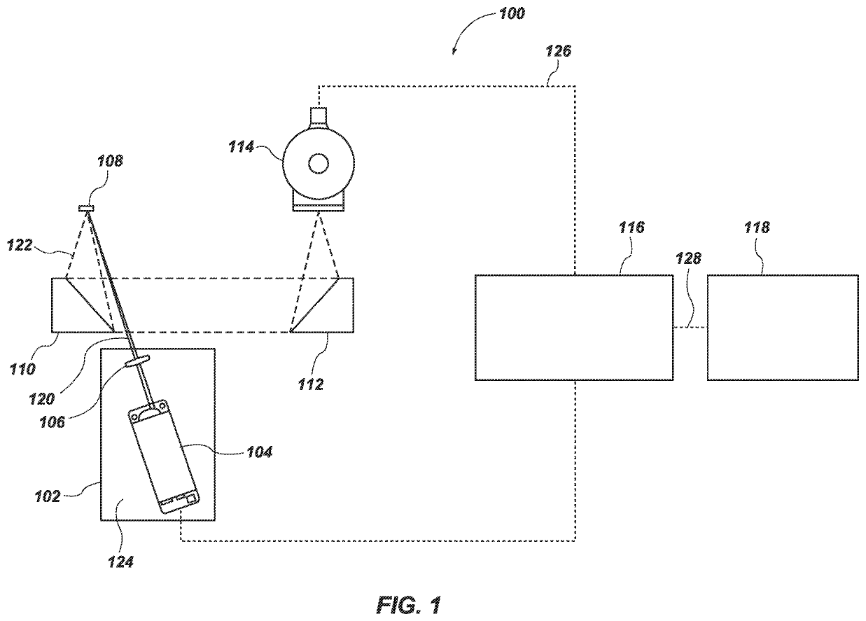

FIG. 1 illustrates a schematic view of a PTR system 100 that may be used to take PTR measurements of a structure 108 to be analyzed. The structure 108 may include structures within a nuclear reactor (e.g., fuel rods, containment structures, heat exchangers, downtubes, flow control devices, etc.), sintered structures (e.g., sintered materials leaving a CEFAS system, sintered materials removed from the mold of an EFAS system, or sintered materials removed from other conventional sintering systems), and structures being sintered (e.g., materials within a mold of an EFAS system, materials passing through a CEFAS system, materials within a mold or press of other conventional sintering systems), vehicle structures (e.g., automobile structures, aircraft structures, heavy equipment structures, etc.), building structures (e.g., bridges, commercial buildings, amusement park rides, trusses, etc.), and other structures that may be subjected to non-destructive testing. The PTR system 100 may include a scan apparatus 102, which may include a laser 104 and a lens 106. The laser 104 may be configured to direct a laser beam 120 toward a surface of the structure 108. The PTR system 100 does not need a specially prepared surface, such as a polished optical quality surface, or specific shape, of the structure 108. Therefore, any surface of the structure 108 may be analyzed and the structure 108 may have a non-uniform shape, such as a fragmented sample. Analyzing a single surface of the structure 108 may be sufficient to determine the thermal diffusivity of a material of the structure 108 at a high accuracy. The laser 104 may be configured to have an adjustable modulation frequency. The lens 106 may be configured to adjust a contact area of the laser beam 120 at the structure 108. In some embodiments, the lens 106 is configured to reduce the contact area of the laser beam 120 (e.g., to concentrate the laser beam 120). In other embodiments, the lens 106 is configured to increase the contact area of the laser beam 120 (e.g., to expand the laser beam 120). A size of the contact area of the laser beam 120 may also be adjusted by changing a distance between the scan apparatus 102 and the surface of the structure 108. The contact area of the laser beam 120 may be in a range from about 0.05 mm to about 2 mm, such as from about 0.1 mm to about 1 mm. The scan apparatus 102 may include a moving stage 124. The stage 124 may be configured to maintain an orientation and spacing of the laser 104 and lens 106 relative to the structure 108. For example, the laser 104 and lens 106 may be secured to the stage 124. In some embodiments, the laser 104 and lens 106 are rotatably secured to the stage 124, such that an angle of incidence of the laser beam 120 relative to the surface of the structure 108 may be adjusted by rotating the assembly of the laser 104 and the lens 106 on the stage 124. The stage 124 may be configured to travel laterally along a track or rail (not shown), such that the stage 124 maintains a constant distance between the surface of the structure 108, laser 104, and lens 106 assembly over multiple different positions.

The structure 108 is heated locally (e.g., in the contact area and locations near the contact area) by the laser beam 120. The heated area of the structure 108 may release thermal magnetic radiation 122, such as blackbody radiation. The thermal magnetic radiation 122 may be reflected by one or more mirrors 110, 112 configured to redirect the thermal magnetic radiation 122 to a detector 114. The detector 114 may be a photodetector, such as a monochromator, an infrared spectrometer, a liquid nitrogen cooled monochromator, or a liquid nitrogen cooled infrared spectrometer. In some embodiments, the detector 114 is a cryogenically cooled detector, such as a liquid nitrogen cooled monochromator, or a liquid nitrogen cooled infrared spectrometer. In some embodiments, the one or more mirrors 110, 112 are two parabolic mirrors 110, 112 that are arranged as 90° off-axis parabolic mirrors, where each of the mirrors 110, 112 is configured to change a direction of the associated thermal magnetic radiation 122 by about 90°. In the embodiment illustrated in FIG. 1, the thermal magnetic radiation 122 released from the structure 108 contacts a first mirror 110, which is a 90° off-axis parabolic mirror that directs the thermal magnetic radiation 122 in a lateral direction parallel to the surface of the structure 108. The thermal magnetic radiation 122 then contacts a second mirror 112, which is also a 90° off-axis parabolic mirror that directs the thermal magnetic radiation 122 in a direction substantially parallel and opposite to the thermal magnetic radiation 122 leaving the structure 108. The thermal magnetic radiation 122 leaving the second mirror 112 is then collected by the detector 114. The mirrors 110, 112 may also be configured to control a size and/or shape of the thermal magnetic radiation 122. For example, thermal magnetic radiation 122 is released in a diffused or expanding path as illustrated in FIG. 1. The first mirror 110 may be configured to maintain the thermal magnetic radiation 122 in a substantially straight path (e.g., not expanding or contracting) after the thermal magnetic radiation 122 is reflected off of the surface of the first mirror 110. The second mirror 112 may be configured to contract or focus a path of the thermal magnetic radiation 122, such that the thermal magnetic radiation 122 may be concentrated on a smaller collection surface or aperture of the detector 114. The arrangement of the scan apparatus 102, the mirrors 110, 112, and the detector 114 may facilitate taking measurements from a same side of the structure 108, such that the PTR system 100 may be used on structures 108 where there is no access to a back side of the structure 108.

The detector 114 may produce a signal 126, such as an electronic signal or analog signal corresponding to the thermal magnetic radiation 122 measured by the detector 114. The signal 126 may be a thermal wave having an amplitude that is periodic in both spatial and temporal domains. The signal 126 may be transmitted to processing circuitry 116, such as an amplifier, rectifier, converter, etc., that is configured to process the signal 126 into a computer-readable format. The processing circuitry 116 may be operably coupled to a computing device 118. The processing circuitry 116 may transmit a processed signal 128 to the computing device 118, which may be configured to store and/or further process the processed signal 128. For example, the computing device 118 may produce results in a spreadsheet or other list or database-type format. In some embodiments, the computing device 118 is configured to provide graphical representations, such as graphs, overlays, hue or intensity maps, etc., on a graphical user interface (GUI) or display. In some embodiments, the computing device 118 is configured to calculate a thermal diffusivity of the structure using the thermal magnetic radiation measurements.

The PTR system 100 may be used to measure thermal magnetic radiation and/or thermal diffusivity from a substantially flat surface of the structure 108, such as a single flat surface of the structure 108. The configuration of the PTR system 100 facilitates performing the measurements on surfaces of the structure 108 that are not specially prepared (e.g., not polished or cut), such that the thermal diffusivity may be measured on production parts without first conducting any special processing. This may result in the PTR system 100 being used to measure thermal diffusivity while the structure 108 is being formed or immediately after the structure 108 is formed. The PTR system 100 may be used with small samples having complex (e.g., non-standard) geometries and where doubled sided access to the samples is not possible.

In some embodiments, optical fibers (not shown) may be used to communicate the laser beam 120 to a surface of the structure 108 and/or to communicate the released thermal magnetic radiation 122 from the surface of the structure 108 to the detector 114. The optical fibers may facilitate positioning the detector 114 and laser 104 remote from the structure 108. For example, the optical fibers may facilitate taking measurements of the structure 108 during a sintering process, such as in an EFAS chamber, or taking measurements within a nuclear reactor. The optical fiber may extend through a wall of the surrounding material between the surface of the structure 108 and the laser 104, the detector 114, and/or the mirrors 110, 112.

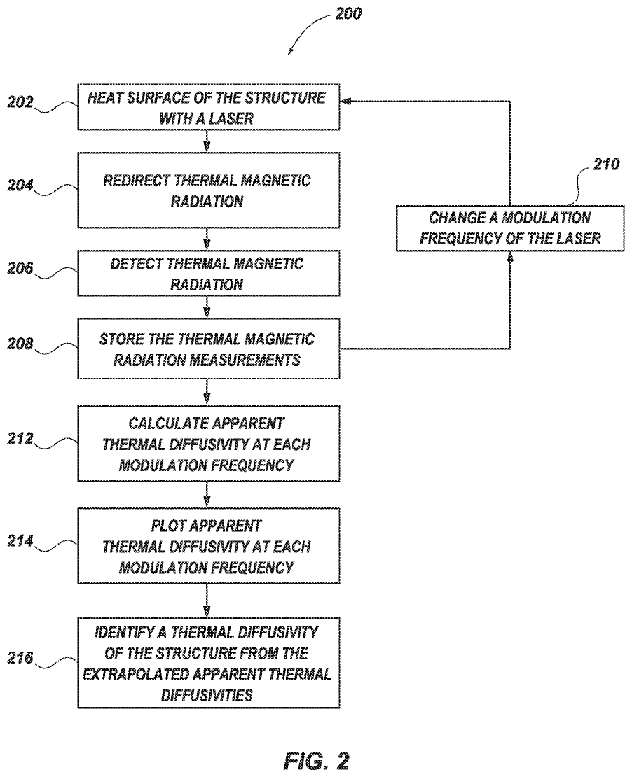

FIG. 2 illustrates a flow chart representative of a method of measuring the thermal diffusivity of a structure 200. As discussed above, a surface of the structure is heated using a laser focused on the surface in act 202. The laser may be set to an initial modulation frequency, such as a low modulation frequency (e.g., in a range from about 0.5 Hz to about 5 Hz), an intermediate modulation frequency (e.g., in a range from about 2 Hz to about 20 Hz), or a high modulation frequency (e.g., in a range from about 10 Hz to about 500 Hz). The heated surface of the structure 200 may release radiation in the form of thermal magnetic radiation.

The thermal magnetic radiation may be redirected (e.g., expanded, concentrated) through one or more mirrors in act 204. As described above, the thermal magnetic radiation may be reflected between two parabolic mirrors to redirect the thermal magnetic radiation toward a detector and concentrate or expand the thermal magnetic radiation on a sensing portion of the detector. The detector may measure (e.g., detect) the thermal magnetic radiation in act 206. The laser may scan over a surface of the structure and the detector may measure the thermal magnetic radiation at multiple positions across the surface of the structure. The measurements may then be stored in act 208. For example, the measurements may be stored in a memory of a computing device, such as in a database.

After measuring the thermal magnetic radiation and storing the thermal magnetic radiation measurements in acts 206 and 208, the modulation frequency of the laser may be changed to a secondary modulation frequency in act 210. The secondary modulation frequency is a different frequency from the initial modulation frequency. For example, the secondary modulation frequency may be in a different range (e.g., low modulation frequency range, intermediate modulation frequency range, or high modulation frequency range) than the initial modulation frequency. After changing the modulation frequency of the laser in act 210, acts 202 through 208 may be repeated at the secondary modulation frequency. In some embodiments, the modulation frequency of the laser is changed multiple times, such that the measurements of the thermal magnetic radiation are taken at more than two modulation frequencies, such as at three different modulation frequencies, at four different modulation frequencies, or at five different modulation frequencies.

The thermal magnetic radiation measurements at each of the different modulation frequencies may be used to calculate an apparent thermal diffusivity at each modulation frequency in act 212. The apparent thermal diffusivity may be calculated based on a relationship between the heat energy input into the structure and the thermal electromagnetic radiation released from the structure. The apparent thermal diffusivities at each of the different modulation frequencies may then be plotted in act 214. The computing device 118 may define a curve fit to the plotted apparent thermal diffusivities. The curve fit to the plotted apparent thermal diffusivities may then be extrapolated to illustrate converging boundary conditions.

The converging boundary conditions (e.g., as the extrapolated curve approaches zero Hz or infinite Hz) from the extrapolated apparent thermal diffusivity calculations may be used to identify an actual thermal diffusivity of the structure in act 216. Optical diffraction and a non-linear transfer function may introduce some level of uncertainty into the individual apparent thermal diffusivity calculations. However, taking measurements at multiple different frequencies may minimize the uncertainties as the optical diffraction and non-linear transfer functions are reduced to substantially a value of zero having little to no effect on the thermal diffusivity at the boundary conditions. Thus, the boundary regions of the extrapolated apparent thermal diffusivity calculations are substantially the same as the actual thermal diffusivity of the structure.

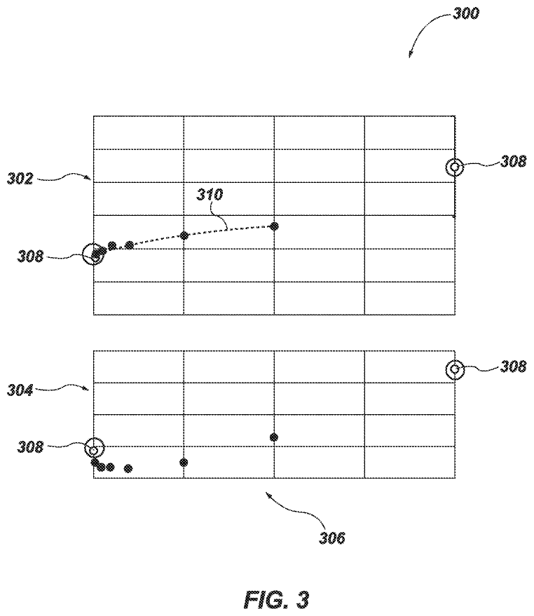

FIG. 3 is a graph 300 including the apparent thermal diffusivity 302 at different frequencies 306 and the curve fit error 304 of the apparent thermal diffusivities 302 at each frequency 306. When curve fitting the plotted apparent thermal diffusivities 302, the computing device 118 may evaluate the curve fit error 304 of each of the plotted apparent thermal diffusivities 302. The curve fit error 304 may be used to identify values of the apparent thermal diffusivities 302 that were taken where the uncertainty caused by optical diffraction and/or a non-linear transfer functions are greater than a threshold level.

The apparent thermal diffusivities 302 that are identified as having a curve fit error 304 greater than the threshold level may be excluded from the extrapolation calculation to improve accuracy of the extrapolation. The threshold values of the curve fit error 304 may be defined differently on opposing ends of the frequency range (e.g., higher frequency vs. low frequency). For example, the threshold curve fit error 304 value for low frequencies may be defined by the surrounding data. For example, the threshold value of the curve fit error 304 at the low-frequency end of the spectrum may be in a range from about 1.5 times the minimum curve fit error 304 to about 3 times the minimum curve fit error 304, such as about 2 times the minimum curve fit error 304. On the high-frequency end of the spectrum, the threshold value of the curve fit error 304 may be defined as a value of the curve fit error 304 without reference to surrounding values. For example, the threshold value of the curve fit error 304 at the high-frequency end may be in a range from about 0.1 mm²/second to about 0.4 mm²/s, such as about 0.2 mm²/s.

In the graph 300, the values of the thermal diffusivity 302 include an excluded data point 308 bounding the data set on the low-frequency end and an excluded data point 308 bounding the data set on the high-frequency end. The two excluded data points 308 are not included in the calculation of the extrapolated curve 310. As discussed above, the extrapolated curve 310 may be used to estimate the actual thermal diffusivity of the associated material at the boundary regions of the extrapolated curve 310 (e.g., as the extrapolated curve 310 approaches an infinite frequency 306).

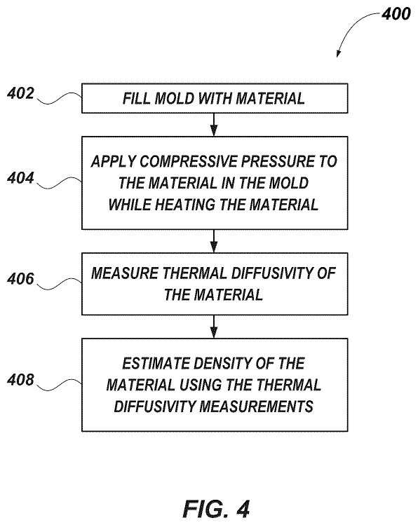

FIG. 4 illustrates a flow chart representative of a method 400 of calculating the density of a material. A mold may be filled with a material that will be formed into a structure in act 402. The material may be a powdered material, such as a powdered ceramic material or a powdered metal material. The material may be an advanced energy material used in nuclear fuel applications or a material associated with advanced energy systems and advanced synthesis techniques. For instance, the material may be another advanced energy material, small, exotic single crystals grown using hydrothermal growth techniques, or additively manufactured components having complex geometries. The material may, for example, be uranium oxide or a moderator material, such as graphite. Other non-limiting example materials are fused silica, calcium fluoride (CaF₂), zinc selenide (ZnSe), zinc sulfide (ZnS), Tungsten (W), alumina (Al₂O₃), boron carbide (B₄C), etc. The structure may be formed through a sintering process, such as an EFAS or SPS process, where a compressive force is applied to the material in the mold while the material is heated in act 404. As discussed above, the material may be heated by applying a current through the material in an EFAS or SPS process. The thermal diffusivity of the material may then be measured in act 406. For example, the thermal diffusivity of the material may be measured in act 406 through the method of measuring the thermal diffusivity of a structure 200 described above. The PTR system 100 described above may facilitate performing the method of measuring the thermal diffusivity of a structure 200 while the structure is in the mold, such as between sintering processes or immediately following a sintering process.

The thermal diffusivity may be used to estimate a density or local porosity of the material or structure in act 408. For example, the thermal diffusivity of a material is related to a density of the material through the following relationship:

$$α = \frac{k}{ρ {C}_{p}}$$

Where α is the thermal diffusivity of the material, k is the thermal conductivity of the material, ρ is the density of the material, and Cₚ is the specific heat of the material. Thus, the density of the material may be found using the thermal diffusivity measured in act 406 along with other known properties of the material. Even if the other material properties of the material are not known, the density of the material may be estimated due to the known relationship between the material density and the thermal diffusivity of the material. For example, a relative density in different portions of the structure and/or with respect to other structures formed from the same material may be estimated through the relationship.

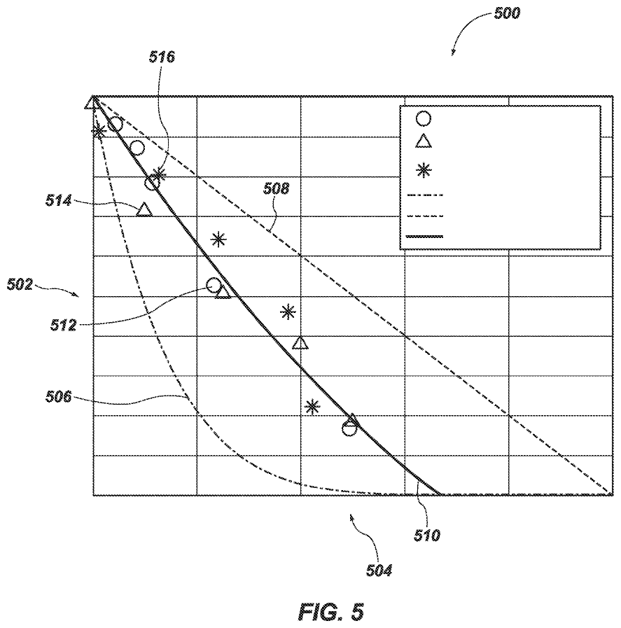

FIG. 5 illustrates a graph 500 illustrating the relationship between porosity 504 of a material and the thermal conductivity 502 of the material. The graph 500 includes measured thermal conductivity 502 values for a first material 512, a second material 514, and a third material 516 at different measured porosities 504. For example, the values of the first material 512 are represented by circles, the values of the second material 514 are represented by triangles, and the values of the third material 516 are represented by asterisks.

The measured values of the first material 512, the second material 514, and the third material 516 are plotted against a percolation threshold model. The percolation threshold model includes an upper bound 508, a lower bound 506, and a percolation line 510. The lower bound 506 is defined by the following relationship:

$${k}_{ul} = {( 1 - ϕ )}^{7}$$

where kᵤₗ represents the thermal conductivity and φ represents the porosity. The upper bound 508 is defined by the following relationship:

$${k}_{ur} = ( 1 - ϕ )$$

where kᵤᵣ represents the thermal conductivity and φ represents the porosity. The percolation line 510 is defined by the following relationship:

$$ϕ = \frac{2 {k}_{0} + {k}_{0} {ϕ}_{C} - 2 \sqrt{\frac{{k}_{0} ( 4 {k}_{0} - 4 {k}_{0} {ϕ}_{C} + 8 k {ϕ}_{C} + {k}_{0} {ϕ}_{C}^{2}}{4}}}{2 {k}_{0}}$$

wherein k₀ represents the thermal conductivity of a pore free material, which can be found in literature, φ represents the porosity, and de represents the percolation threshold number, which is ⅔ for spherical pores. As illustrated in FIG. 5, the measured values are closely related to the percolation line 510, such that the percolation line 510 may provide a reasonable estimate for the porosity 504 of a material based on a measured thermal conductivity 502. Notably, the differences between the porosity 504 values estimated using the percolation threshold model and the actual values are less than differences found in porosity estimates performed through image processing methods, in particular, at relatively high densities.

Thermal diffusivity may also be used to measure local densities of a material by using multiple probes. Using multiple probes during a sintering process may facilitate adjustments to sintering parameters to produce a sintered product having a more uniform density.

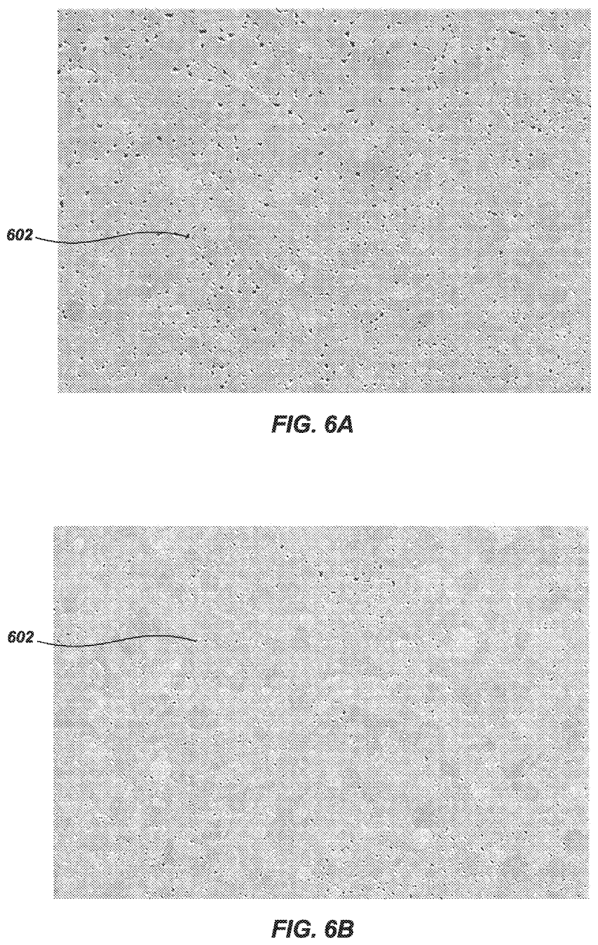

FIGS. 6A and 6B are electron microscope images of two different regions of a material. As illustrated in FIGS. 6A and 6B, the material has multiple pores 602 that can be seen in the images. FIG. 6A has a greater concentration of the pores 602 than FIG. 6B. As these images are taken from different regions of the same material, the bulk density measurements may not capture the reduced density of the region represented in FIG. 6A. However, taking multiple localized measurements by placing probes in multiple locations within the sintering assembly may facilitate measuring regions having lower densities, such as the region illustrated in FIG. 6A. If a region having a lower density is found, one or more parameters of the sintering process may be adjusted to increase the density in the lower density region. For example, changes may be made to the temperature of the sintering assembly, the current being provided to the sintering assembly, the pressure being applied by the sintering assembly, etc., to increase the density in the lower density region Embodiments of the disclosure may facilitate measuring thermal diffusivity of a material in situ during or after a sintering process. Measuring the thermal diffusivity of the material facilitates calculating or estimating the density of the material. Density measurements of the material may facilitate decisions, such as which types of products or processes the material or structure may be used with.

Thermal diffusivity may be used to substantially instantly estimate density of sintered materials without interrupting the sintering process. By deploying multiple probes, it can also be used to examine local density variation so that the sintering parameters can be dynamically adjusted to enhance the desired microstructure features (e.g., to fabricate Functionally Graded Materials) or avoid unexpected heterogeneities.

Exemplary embodiments of the disclosure include:
Embodiment 1: A non-destructive testing system comprising: a laser having an adjustable modulation frequency; a first mirror configured to intercept and redirect thermal electromagnetic radiation released by a structure after the laser heats a surface of a material of the structure; a second mirror configured to intercept, redirect, and concentrate the thermal electromagnetic radiation after the thermal electromagnetic radiation is intercepted and redirected by the first mirror; and a detector configured to receive and measure the thermal electromagnetic radiation after the thermal electromagnetic radiation is intercepted, redirected, and concentrated by the second mirror.
Embodiment 2: The non-destructive testing system of embodiment 1, further comprising a computing device configured to receive and store measurements of the thermal electromagnetic radiation from the detector.
Embodiment 3: The non-destructive testing system of embodiment 2, wherein the laser is configured to be set at multiple different modulation frequencies, the detector is configured to receive and measure the thermal electromagnetic radiation of the material of the structure at each of the multiple different modulation frequencies, and the computing device is configured to receive and store the measurements of the thermal electromagnetic radiation at each of the modulation frequencies.
Embodiment 4: The non-destructive testing system of any one of embodiments 2 or 3, wherein the computing device is configured to receive the measurements of the thermal electromagnetic radiation from the detector in a form of a thermal wave with an amplitude that is periodic in both spatial and temporal domains.
Embodiment 5: The non-destructive testing system of any one of embodiments 1 through 4, further comprising one or more optical fibers positioned between the laser and the structure.
Embodiment 6: The non-destructive testing system of any one of embodiments 1 through 5, wherein the detector comprises a photodetector.
Embodiment 7: The non-destructive testing system of any one of embodiments 1 through 6, wherein the detector comprises a cryogenically cooled detector.
Embodiment 8: The non-destructive testing system of any one of embodiments 1 through 7, further comprising a stage configured to move laterally along a track or rail of the non-destructive testing system, wherein the laser is secured to the stage.
Embodiment 9: The non-destructing testing system of embodiment 8, wherein the laser is rotatably secured to the stage.
Embodiment 10: A method of measuring a thermal diffusivity of a structure, the method comprising: heating a surface of a material of the structure with a laser having a first modulation frequency; measuring a first value of thermal electromagnetic radiation released by the structure; storing, in a memory device, the first value of the thermal electromagnetic radiation released by the structure; changing a modulation frequency of the laser to a second modulation frequency different from the first modulation frequency; heating the surface of the material of the structure with the laser having the second modulation frequency; measuring a second value of the thermal electromagnetic radiation released by the structure at the second modulation frequency; storing, in the memory device, the second value of the thermal electromagnetic radiation released by the structure; changing the modulation frequency of the laser to a third modulation frequency different from the first modulation frequency and the second modulation frequency; heating the surface of the material of the structure with the laser having the third modulation frequency; measuring a third value of the thermal electromagnetic radiation released by the structure at the third modulation frequency; storing, in the memory device, the third value of the thermal electromagnetic radiation released by the structure; extrapolating a thermal diffusivity curve of the structure using the first value, the second value, and the third value; and identifying the thermal diffusivity of the structure as a value of the thermal diffusivity curve in a boundary region of the thermal diffusivity curve.
Embodiment 11: The method of embodiment 10, further comprising: calculating a first apparent thermal diffusivity from the first value of the thermal electromagnetic radiation; calculating a second apparent thermal diffusivity from the second value of the thermal electromagnetic radiation; and calculating a third apparent thermal diffusivity from the third value of the thermal electromagnetic radiation.
Embodiment 12: The method of embodiment 11, wherein extrapolating the thermal diffusivity curve of the structure further comprises fitting a curve to the calculated first apparent thermal diffusivity, the calculated second apparent thermal diffusivity, and the calculated third apparent thermal diffusivity.
Embodiment 13: The method of embodiment 12, wherein extrapolating the thermal diffusivity curve of the structure further comprises: identifying at least one of the first apparent thermal diffusivity, the second apparent thermal diffusivity, and the third apparent thermal diffusivity as an excluded datapoint; and extrapolating the thermal diffusivity curve of the structure without the excluded datapoint.
Embodiment 14: The method of embodiment 13, wherein identifying at least one of the first apparent thermal diffusivity, the second apparent thermal diffusivity, and the third apparent thermal diffusivity as an excluded datapoint comprises: calculating a curve fit error for each of the first apparent thermal diffusivity, the second apparent thermal diffusivity, and the third apparent thermal diffusivity; and identifying the at least one of the first apparent thermal diffusivity, the second apparent thermal diffusivity, and the third apparent thermal diffusivity as the excluded datapoint where the curve fit error of the excluded datapoint is greater than a threshold value.
Embodiment 15: A method of forming a structure, the method comprising: filling a mold with a material; sintering the material in the mold while applying a current to the material; measuring a thermal diffusivity of the material in the mold; and calculating a density of the material in the mold using the thermal diffusivity of the material.
Embodiment 16: The method of embodiment 15, wherein measuring the thermal diffusivity of the material in the mold includes measuring the thermal diffusivity of the material in the mold while sintering the material in the mold.
Embodiment 17: The method of any one or embodiments 15 or 16, wherein measuring the thermal diffusivity of the material in the mold includes measuring the thermal diffusivity of the material in the mold after sintering the material in the mold.
Embodiment 18: The method of any one of embodiments 15 through 17, wherein measuring the thermal diffusivity of the material in the mold comprises: locally heating the material in the mold with a laser; and measuring thermal electromagnetic radiation released from the material.
Embodiment 19: The method of embodiment 18, wherein locally heating the material in the mold with the laser comprises locally heating a surface of the material by directing the laser to the surface of the material in the mold through an optical fiber extending through the mold.
Embodiment 20: The method of any one of embodiments 15 through 19, further comprising adjusting one or more parameters of a sintering mechanism while sintering the material in the mold based on the density of the material in the mold calculated using the thermal diffusivity of the material.

The embodiments of the disclosure described above and illustrated in the accompanying drawing figures do not limit the scope of the invention, since these embodiments are merely examples of embodiments of the invention, which is defined by the appended claims and their legal equivalents. Any equivalent embodiments are intended to be within the scope of this disclosure. Indeed, various modifications of the present disclosure, in addition to those shown and described herein, such as alternative useful combinations of the elements described, may become apparent to those skilled in the art from the description. Such modifications and embodiments are also intended to fall within the scope of the appended claims and their legal equivalents.

1. A non-destructive testing system comprising:
a laser having an adjustable modulation frequency;
a first mirror configured to intercept and redirect thermal electromagnetic radiation released by a structure after the laser heats a surface of a material of the structure;
a second mirror configured to intercept, redirect, and concentrate the thermal electromagnetic radiation after the thermal electromagnetic radiation is intercepted and redirected by the first mirror; and
a detector configured to receive and measure the thermal electromagnetic radiation after the thermal electromagnetic radiation is intercepted, redirected, and concentrated by the second mirror.

2. The non-destructive testing system of claim 1, further comprising a computing device configured to receive and store measurements of the thermal electromagnetic radiation from the detector.

3. The non-destructive testing system of claim 2, wherein the laser is configured to be set at multiple different modulation frequencies, the detector is configured to receive and measure the thermal electromagnetic radiation of the material of the structure at each of the multiple different modulation frequencies, and the computing device is configured to receive and store the measurements of the thermal electromagnetic radiation at each of the modulation frequencies.

4. The non-destructive testing system of claim 2, wherein the computing device is configured to receive the measurements of the thermal electromagnetic radiation from the detector in a form of a thermal wave with an amplitude that is periodic in both spatial and temporal domains.

5. The non-destructive testing system of claim 1, further comprising one or more optical fibers positioned between the laser and the structure.

6. The non-destructive testing system of claim 1, wherein the detector comprises a photodetector.

7. The non-destructive testing system of claim 1, wherein the detector comprises a cryogenically cooled detector.

8. The non-destructive testing system of claim 1, further comprising a stage configured to move laterally along a track or rail of the destructive testing system, wherein the laser is secured to the stage.

9. The non-destructing testing system of claim 8, wherein the laser is rotatably secured to the stage.

10. A method of measuring a thermal diffusivity of a structure, the method comprising:
heating a surface of a material of the structure with a laser having a first modulation frequency;
measuring a first value of thermal electromagnetic radiation released by the structure;
storing, in a memory device, the first value of the thermal electromagnetic radiation released by the structure;
changing a modulation frequency of the laser to a second modulation frequency different from the first modulation frequency;
heating the surface of the material of the structure with the laser having the second modulation frequency;
measuring a second value of the thermal electromagnetic radiation released by the structure at the second modulation frequency;
storing, in the memory device, the second value of the thermal electromagnetic radiation released by the structure;
changing the modulation frequency of the laser to a third modulation frequency different from the first modulation frequency and the second modulation frequency;
heating the surface of the material of the structure with the laser having the third modulation frequency;
measuring a third value of the thermal electromagnetic radiation released by the structure at the third modulation frequency;
storing, in the memory device, the third value of the thermal electromagnetic radiation released by the structure;
extrapolating a thermal diffusivity curve of the structure using the first value, the second value, and the third value; and
identifying the thermal diffusivity of the structure as a value of the thermal diffusivity curve in a boundary region of the thermal diffusivity curve.

11. The method of claim 10, further comprising:
calculating a first apparent thermal diffusivity from the first value of the thermal electromagnetic radiation;
calculating a second apparent thermal diffusivity from the second value of the thermal electromagnetic radiation; and
calculating a third apparent thermal diffusivity from the third value of the thermal electromagnetic radiation.

12. The method of claim 11, wherein extrapolating the thermal diffusivity curve of the structure further comprises fitting a curve to the calculated first apparent thermal diffusivity, the calculated second apparent thermal diffusivity, and the calculated third apparent thermal diffusivity.

13. The method of claim 12, wherein extrapolating the thermal diffusivity curve of the structure further comprises:
identifying at least one of the first apparent thermal diffusivity, the second apparent thermal diffusivity, and the third apparent thermal diffusivity as an excluded datapoint; and
extrapolating the thermal diffusivity curve of the structure without the excluded datapoint.

14. The method of claim 13, wherein identifying at least one of the first apparent thermal diffusivity, the second apparent thermal diffusivity, and the third apparent thermal diffusivity as an excluded datapoint comprises:
calculating a curve fit error for each of the first apparent thermal diffusivity, the second apparent thermal diffusivity, and the third apparent thermal diffusivity; and
identifying the at least one of the first apparent thermal diffusivity, the second apparent thermal diffusivity, and the third apparent thermal diffusivity as the excluded datapoint where the curve fit error of the excluded datapoint is greater than a threshold value.

15. A method of forming a structure, the method comprising:
filling a mold with a material;
sintering the material in the mold while applying a current to the material;
measuring a thermal diffusivity of the material in the mold; and
calculating a density of the material in the mold using the thermal diffusivity of the material.

16. The method of claim 15, wherein measuring the thermal diffusivity of the material in the mold includes measuring the thermal diffusivity of the material in the mold while sintering the material in the mold.

17. The method of claim 15, wherein measuring the thermal diffusivity of the material in the mold includes measuring the thermal diffusivity of the material in the mold after sintering the material in the mold.

18. The method of claim 15, wherein measuring the thermal diffusivity of the material in the mold comprises:
locally heating the material in the mold with a laser; and
measuring thermal electromagnetic radiation released from the material.

19. The method of claim 18, wherein locally heating the material in the mold with the laser comprises locally heating a surface of the material by directing the laser to the surface of the material in the mold through an optical fiber extending through the mold.

20. The method of claim 15, further comprising adjusting one or more parameters of a sintering mechanism while sintering the material in the mold based on the density of the material in the mold calculated using the thermal diffusivity of the material.
